(19) United States
(12) Patent Application Publication
(10) Pub. No.: US 2006/0150622 A1
(43) Pub. Date: Jul. 13, 2006

(54) Hydraulic machine of boosting and recovery of the liquid in internal movements in the electric energy produciton

(76) Inventor: Mario Teixeira Cavalheiro, Santos-SP (BR)

Correspondence Address: FLESHNER & KIM, LLP, P.O. BOX 221200, CHANTILLY, VA, 20153, US

(21) Appl. No.: 10/525,511

(22) PCT Filed: Dec. 15, 2003
(86) PCT No.: PCT/BR03/00196

§ 371 Date: Feb. 24, 2005

(30) Foreign Application Priority Data
Jan. 14, 2003 (BR) PI 0300098-2
Oct. 22, 2003 (BR) PI 0304573-0

(51) Int. Cl. F16D 31/02

(52) U.S. Cl. 60/398

(57) ABSTRACT

The hydraulic machine consists one or more steel tank (1), one pipe (2) or more made of steel, level tank (3) made of iron, cylinder (4) chamber built of iron, cylinder (5) built of chromed iron, pneumatic cylinders (6) right side pneumatic cylinders (8), pneumatic cylinder (9), plug or valve (10) built of metal, guide-stem (11) of ascent and descent of the cylinder with back-stand of roller-bearings in the left side, guide-stem (12) of the cylinder in the ascent and descent with roller-bearings back-stand, balancing external weight (13), pulley (14), where the weight cable is fastened, pulley (15) that fixes the weight cable, and makes the effort of the movement of the central axle through an electric motor (17), central axle pulley (24) that pulls the cylinder (32) upwards and downwards trough the cable (25) that fixes the cylinder (32) to the central axle pulley (24), central axle (26) of the machine movement where the cables with inverted direction are fastened and give movement to the external weight (13) and to the internal cylinder (5), and a pipe (28) which feeds the water to the machine turbine (27).

This patent of invention refers to a machine specially developed for production of electric power, which through the movement of one or more cylinders, depending on the size of the machine, embedded in one sleeve or more exerts its movement upwards and downwards. Said sleeve and the cylinder are inside the tank or water column and inside it perform their movements. In the sleeve there is a ring that seals the exit of the water or other liquids from the tank to outside. And also allows the transference of the liquid from the sleeve to the tank number one. This ring when leaned against the wall allows the cylinder to be displaced from down to up and generates an empty space in the interior of its sleeve that is immediately occupied by the water or other liquid through the opening of the plug or valve existent in the recovery box that was used in the movement of the rotor. Note that this box is higher than the level of the sleeve where is the cylinder to thus allow the internal invasion of the water as result of the difference of level. Closed the plug of the water box and opened the ring, the cylinder makes the inverse course and exerts the boosting of the water or other liquids through the opening of the ring, which makes possible to execute new movements in high speed in the transference of the liquid from the sleeve to the tank number one. But, everything becomes easy, the liquid transference is immediate and with little effort, as the cylinder and the chamber are inside the tank one liquid and occupy part of this space. It should be highlighted here the materials to be used in the strains to be executed through a central axle that is moved by a motor that may be electrical or of other type, in this axle are tied two steel cables with tieing in opposite directions, one of the cable holds the central cylinder of the machine, the other cable holds a weight outside the machine and they form a swing between the internal and the external weights, when the cylinder cable goes up the cable of the external weight goes down. When the external weight goes up the cylinder goes down. These movements are well balanced and make the movement of the machine with low energy consumption. In the ring and in the plug or valve it is used pneumatic cylinders due to the need of speed in the production of great volume of liquid in movement. All these movements are duly commanded by sensors installed in several points of the machine.

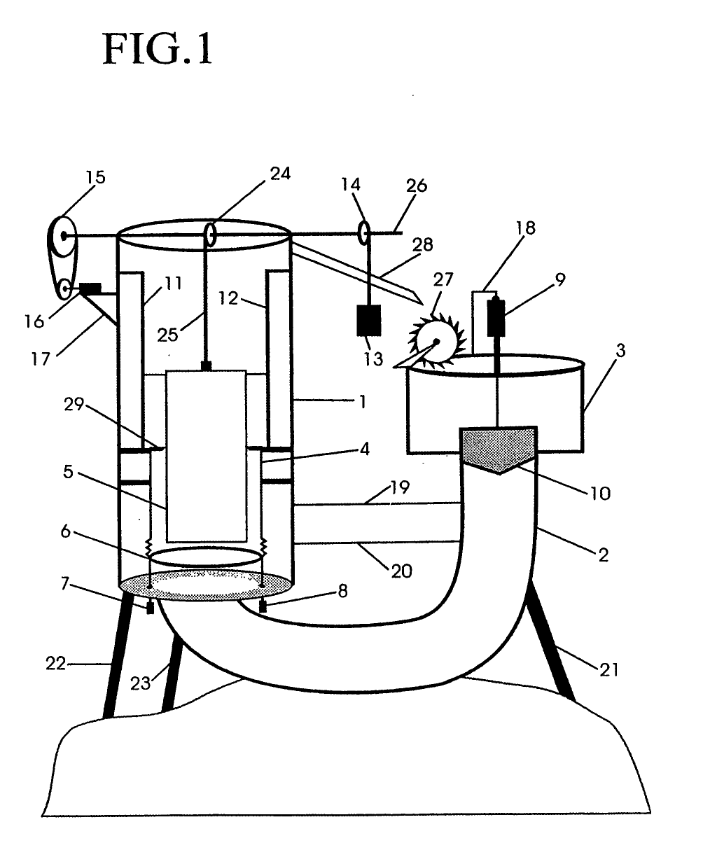

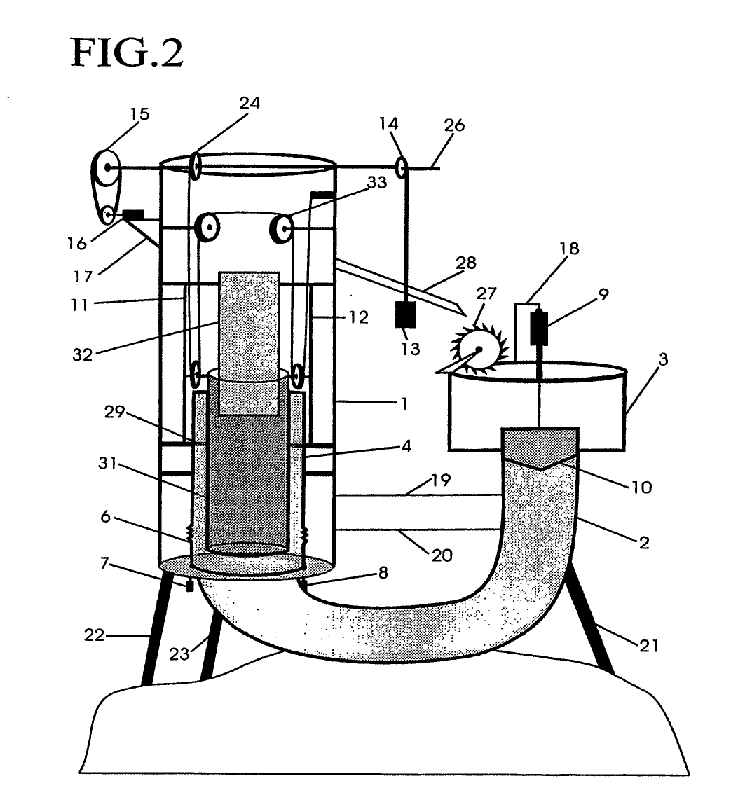

The FIG. (1) shows the machine as a whole, (1) in the tank or water column or other liquids this height varies according to the volume of the water that is required to rotate the rotor. Note that the machine may be of big dimension, for such, it is necessary to use more than one cylinder, the tank may be one or more, depending on the necessity, (2) level pipe of the water from the box to the column, when the cylinder goes up the water immediately invades the space left by the cylinder, (3) water box that receives the flow of the water movement in the turbine rotor and through its level it is possible to recover it and transmit it through the pipe to the cylinder sleeve, (4) cylinder sleeve, this sleeve when the ring leans against it eliminates the flowing of the water out of the interior of the tank to outside and allow us to make the recovery of the liquid that was used in the turbine rotor through the empty space left by the cylinder when it goes up, (5) cylinder that goes up and down, when it goes up with the ring closed it allows the recovery of the water or of the liquids. When it goes down with ring open and the plug closed it discharges the liquid from the interior of the sleeve to the interior of the mother-tank and so raises the water level and causes its falling on the rotor (6) the sealing ring of the cylinder sleeve to the tank, when the cylinder is open it is ready to start its descent, when the cylinder is closed it is ready to start its ascent, (7) pneumatic cylinder, this cylinder has the function of opening and closing the sealing ring, (8) pneumatic cylinder, this cylinder has the same function of the cylinder seven, (9) pneumatic cylinder, this cylinder has the function of opening the plug or valve, depending on what is possible to be faster in the sealing of the passing of the water of the pipe recovery box, (10) plug that makes the sealing of the passing of the water or other liquids, (11) left side cylinder guide-stem, (12) right side cylinder guide-stem, (13) external weight that makes the balance between the internal cylinder and the external weight, (14) pulley fixed to the axle with steel cable that sustains the external weight with inverted tieing, when the cylinder goes down the weight goes up, (15) pulley fastened to the central axle that through an electric motor or other it is possible to spin the axle and impart movements to the machine, (16) electric motor that through a belt is interconnected to the central axle of the machine and exerts the movement of the same, (17) motor supporting table, (18) supporting table of the pneumatic cylinder that gives the movement to the plug, (19) stem of fixing of the machine to the pipe, (20) the machine fixing stem has the same function of the nineteenth, (21) stem of fixing of the pipe to the ground, (22) stem of fixing of the mother-pipe to the ground, (23) stem of holding of the pipe to the ground, (24) pulley fixed to the central axle where is tied a steel cable that when put in movement exerts the function of making the cylinder go up and go down, (25) cable of tieing of the pulley to the cylinder, (26) central axle of the machine where the cables that are fastened to the pulleys rotate in inverse directions, (27) turbine or rotor that through the beating of the water transfers the movement to the generator and in this manner makes possible the production of electric energy, (28) pipe of conduction of the water or other liquid to the turbine rotor, (29) sealing ring of the machine central cylinder, (31) it should be emphasized that the cylinder that goes up and down according to figure, a cylinder five that makes the up and down movement also can be made as the (FIG. 2) will show us, also may be constructed in form of open glass, what facilitates very much, as long as its liquid is displaced by another, (32) cylinder that is stopped and with movement of the cylinder in form of glass, from down to up is made the displacement of the liquid when the cylinder in glass penetrates in the cylinder that is stopped. It should be emphasized that the position (33) of the pulleys are fixed in the lateral of the cylinder in form of glass and not to the center.

1. Hydraulic machine, characterized by the fact of comprising (1) a tank or water column constructed of iron or other materials, in this tank are processed the upward and downward movements of the cylinder and through this movement it is possible to raise the water level and, by its turn, cause the water falling in the director of the turbine rotor, (2) this pipe is opened inside the tank one, its insulation with the entry and exit of the water is made through the ring connected to the cylinder protecting sleeve and it is this pipe that allows the passing of the liquid that was recovered and sent again to the tank number one, (3) water box or other liquids, after the processing of the movement of the rotor, this box recover the used liquid. (4) Cylinder sleeve, being a fundamental part of the machine this item is the one that protects the movement of the cylinder inside the tank and it is in it that is fastened the chamber insulation ring; here is processed the entry and exit of the liquid used in the movements of the machine, (5) cylinder built of iron or other materials that through its internal movements inside the tank one show us that all of its movements are executed inside the liquid, both in its descent and in its ascent the sleeve always meets liquid, what characterizes this machine in its internal movements, (6) mobile ring, this ring allows the external sealing of the liquid and the passage of the liquid from the sleeve to the tank one, the ring may be built in metal or other materials, (7) pneumatic cylinders or others, here the movements also may be mechanical, what does not modify the sense of the construction of the machine, (8) I claim all the movements in general of the machine, since the recovery of the water through the direct contact of the pipe one with the pipe two, the internal movements of the cylinder always inside the liquid, the opening and closing of the ring and the admission of the liquid, the balance of the external weight with the internal cylinder in movement and its form of reduction in the movement effort. Because of this, I claim all the movements in general of this machine, including the tieing of the cables in inverted directions and their respective movements. According to FIG. 2, I claim (9) cylinder with the construction in form of glass with the mouth open and the position (10) of the pulleys fixed in the glass cylinder (11), the cylinder that is stopped or other body that replaces it, and I claim the position of the penetration in the cylinder in form of glass.
